(19) United States
(12) Patent Application Publication
(10) Pub. No.: US 2015/0260361 A1
(43) Pub. Date: Sep. 17, 2015

(54) ILLUMINATING DEVICE

(71) Applicant: LOOMA LIGHTING COMPANY LIMITED, Kowloon (HK)

(72) Inventor: Kuo-Hsiung CHO, Taipei City (TW)

(21) Appl. No.: 14/215,433

(22) Filed: Mar. 17, 2014

(51) Int. Cl. F21S 4/00; F21V 31/00; F21K 99/00

(52) U.S. Cl. CPC F21S 4/006; F21K 9/30; F21V 31/005; F21Y 2101/02

(57) ABSTRACT

The present invention is directed to an illuminating device. The illuminating device comprises a bendable carrier and at least a bendable light emitting diode stripe. The bendable carrier has a belt structure with an arcuate cross-section, and includes a convex surface and a concave surface, to firmly maintain the bendable carrier in an elongated state when the bendable carrier is not bent; it also enables the bendable carrier to recover o the elongated state from a bent state. The bendable light emitting diode stripe comprise multiple light emitting diode chips, wherein the bendable light emitting diode stripe is directly arranged on the convex surface or the concave surface or interior space of a flexible tube. By using a belt structure such like tape measure, different shapes of the illuminating device can be feasibly adjusted. As a result, it solves the problem of limited viewing angle and provides better illumination.

### BACKGROUND OF THE INVENTION

1. Field of the Invention

The present invention relates to an illuminating device, and more particularly to a bendable illuminating device.

2. Description of the Prior Art

Light emitting diodes (LED) have gradually become the mainstream of the illuminating device for its energy-saving, short reaction time and long lifespan. However, limited viewing angle of LED is a major problem which affects consumers' willingness to pay higher price for LED bulbs, LED lamps or other LED lighting devices. Furthermore, because of the limited viewing angle, LED illuminating device is not an ideal member for interior design owing to its passable lighting effects.

In this consideration, an illuminating device which is bendable and can be easily adjusted to desired shape should be developed to solve the problem of limited viewing angle.

### SUMMARY OF THE INVENTION

The present invention is directed to an illuminating device. By using a belt structure such like tape measure, different shapes of the illuminating device can be feasibly adjusted. As a result, it solves the problem of limited viewing angle and provides better illumination.

According to one embodiment of the present invention, an illuminating device comprises a bendable carrier and at least a bendable light emitting diode stripe. The bendable carrier has a belt structure with an arcuate cross-section, and includes a convex surface and a concave surface, to firmly maintain the bendable carrier in an elongated state when the bendable carrier is not bent; it also enables the bendable carrier to recover to the elongated state from a bent state. The bendable light emitting diode stripe comprise multiple light emitting diode chips, wherein the bendable light emitting diode stripe is arranged at least on one of the convex surface and the concave surface.

According to another embodiment of the present invention, an illuminating device comprises a bendable supporting element, at least a bendable light emitting diode stripe and a flexible tube. The bendable supporting element has a belt structure with an arcuate cross-section, and includes a convex surface and a concave surface, to firmly maintain the bendable carrier in an elongated state when the bendable carrier is not bent; it also enables the bendable carrier to recover to the elongated state from a bent state. The bendable light emitting diode stripe comprises multiple light, emitting diode chips. In respect to the flexible tube, interior space of the flexible tube is parallel separated to a first through hole and the second through hole. The bendable supporting element is arranged in the first through hole and the bendable light emitting diode stripe is arranged in the second through hole. The flexible tube is composed of transparent or translucent materials

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIGS. 1a and 1c schematically illustrate a side elevation view of one embodiment of the present invention;

FIG. 1b is a schematic diagram illustrating the bendable carrier in different bending state according to one embodiment of the present invention;

FIGS. 2a and 2b are side elevation diagrams illustrating the illuminating device according to one embodiment of the present invention;

FIGS. 3a and 3b are side elevation diagrams illustrating the illuminating device according to another embodiment of the present invention;

FIGS. 4a, 4b, 4c, 4d, 4e and 4f are side elevation diagrams illustrating the illuminating device according to another embodiment of the present invention;

FIGS. 5a, 5b, 5c, 5d, 5e, 5f, 5g and 5h are side elevation diagrams illustrating the illuminating device according to still another embodiment of the present invention;

FIGS. 6a, 6b, 6c, 6d, 6e, 6f, 6g, 6h, 6i, 6j, 6k and 6l are side elevation diagrams illustrating the illuminating device according to yet another embodiment of the present invention;

FIGS. 7a and 7b are side elevation diagrams illustrating the illuminating device according to yet another embodiment of the present invention; and

FIGS. 8a, 8b, 8c and 8d are side elevation diagrams illustrating the illuminating device according to yet another embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

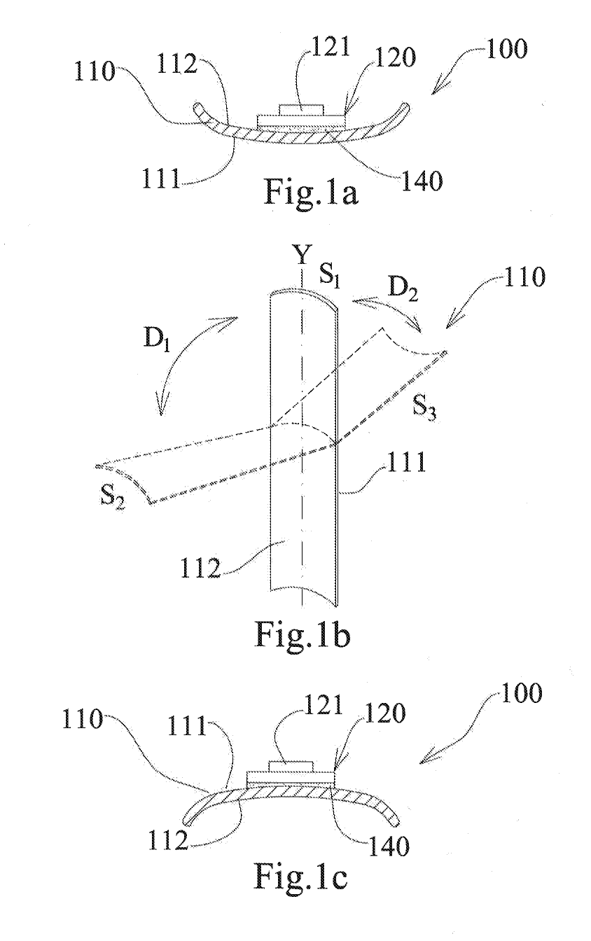

Referring to FIGS. 1a, 1b and 1c, an illuminating device 100 comprises a bendable carrier 110 and at least a bendable light emitting diode stripe 120, The bendable carrier 110 has a belt structure with an arcuate cross-section (as illustrated in FIG. 1a and FIG. 1c), and includes a convex surface 111 and a concave surface 112, to firmly maintain the bendable carrier 110 in an elongated state S₁ when the bendable carrier 110 is not bent (as shown in FIG. 1b); it also enables the bendable carrier 110 to recover to the elongated state from a bent state S₂, S₃. In one embodiment, the bendable carrier 110 can be a stainless steel tapeline or a manganese steel tapeline. The bendable light emitting diode stripe 120 comprises multiple light emitting diode chips 121, wherein the bendable light emitting diode stripe 120 is arranged at least on one of the convex surface 111 (FIG. 1c) and the concave surface 112 (FIG. 1a). In one embodiment the bendable light emitting diode stripe 120 is fastened on at least one of the convex surface 111 and the concave surface 112 by an adhesive layer 140.

Design concept of the illuminating device comes from a roll-up tape measure. When stress is not applied to the bendable carrier 110, the bendable carrier 110 is able to elongate and maintains its shape, such as the elongated state S₁ in FIG. 1b. When users apply stress on the bendable carrier 110, the bendable carrier 110 can be bent or twisted into different shapes according to users' requirement. In order to solve the problem of limited viewing angle, the illuminating device of the present invention can be bent to different shapes to improve the viewing angle.

In regards to mechanical properties of the illuminating device of the present invention, referring to FIG. 1b, when the bendable carrier 110 is in the elongated state S₁, the belt structure has a smaller anti-bending force at a first direction D₁ and has a larger anti-bending force at a second direction D₂, wherein the first direction D₁ is orthogonal to an elongated axis Y of the elongated state S₁ of the belt structure and extends along the plane of a cross-section of the belt structure; the second direction D₂ is opposite to the first direction D₁. The term “Anti-bending force” refers to ability of the bendable carrier to resist external bending force or ability to maintain straight shape of the bendable carrier in the elongated state. In this case, the bendable carrier 110 has anisotropic mechanical properties in two directions. Difference of anti-bending force in two directions implies that there will be tensile stress remained on one side of the bendable carrier 110. When there is no bending force applied to the bendable carrier, tensile stress is able to support the bendable carrier 110 to keep straight without collapsing. When bending force is applied, the bendable carrier 110 can be rolled into the bent state S₂ or S₃.

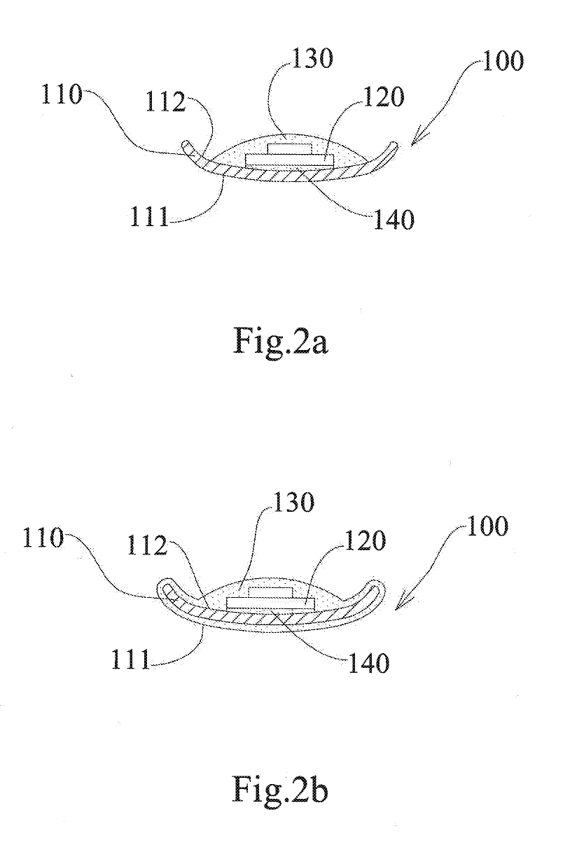

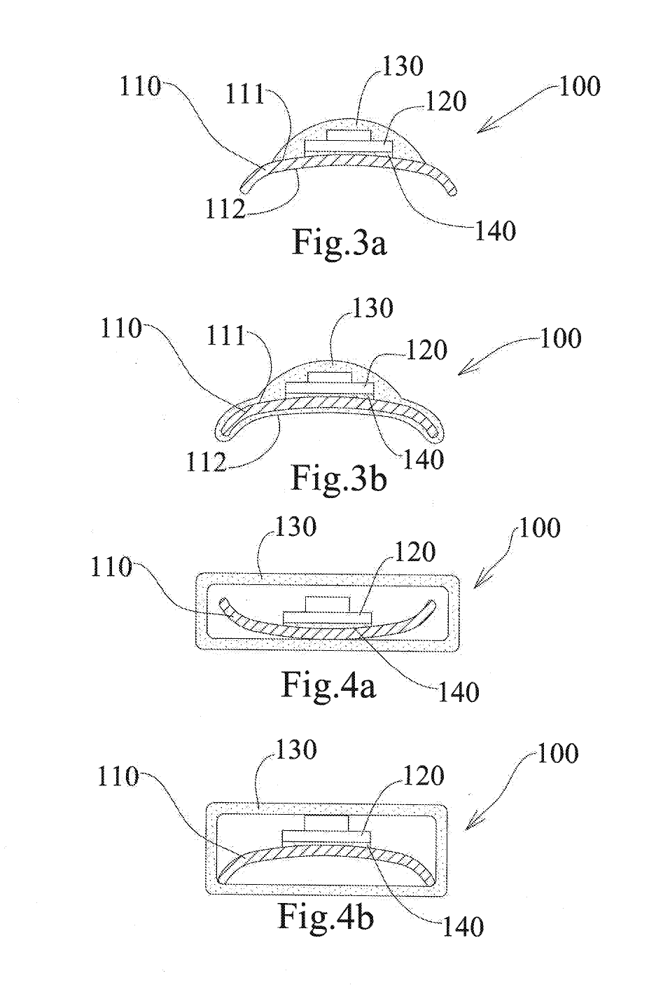

Exposure of the light emitting diode chips 120 may incur damage. To solve this problem, preferably, the illuminating device 100 further comprises a protective medium 130 covering the bendable light emitting diode stripe 120, as illustrated in FIG. 2a. It strengthens attachment of the bendable light emitting diode stripe 120 to the bendable carrier 110. The protective medium 130 can be applied in different forms. In one embodiment, as shown in FIGS. 2a and 2b, the bendable light emitting diode stripe 120 is fastened on the concave surface 112 of the bendable carrier 110 and the protective medium 130 is a sealant layer for closely covering the bendable light emitting diode stripe 120 (FIG. 2a) or closely covering the bendable light emitting diode stripe 120 and the bendable carrier 110 simultaneously (FIG. 2b). In another embodiment, as shown in FIGS. 3a and 3b, the bendable light emitting diode stripe 120 is fastened on the convex surface 111 of the bendable carrier 110 and the protective medium 130 is a sealant layer for closely covering the bendable light emitting diode stripe 120 (FIG. 3a) or closely covering the bendable light emitting diode stripe 120 and the bendable carrier 110 at the same time (FIG. 3b). The concept of the sealant layer 130 comes from LED packaging and it prolongs lifespan of the illuminating device 100. In both cases, the sealant layer is composed of transparent or translucent adhesive sealants to let light pass through the sealant layer.

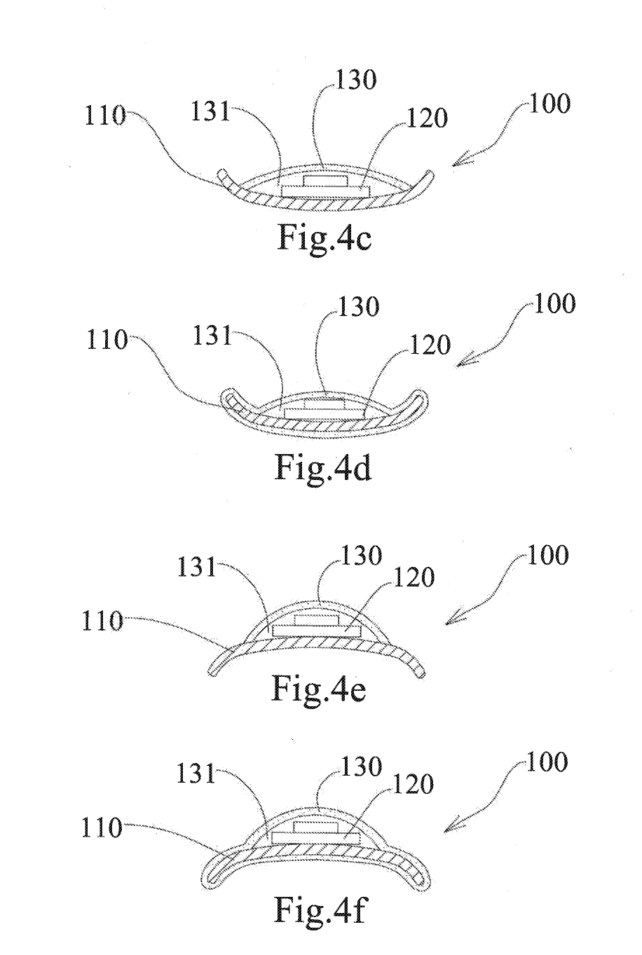

Alternatively, in another embodiment, the protective medium 130 can be a flexible tube covering the bendable light emitting diode stripe 120 and the bendable carrier 110, as shown in FIGS. 4a and 4b. The flexible tube can be composed of transparent or translucent materials to let light pass through. In this structure, the complicated fabrication process of molding can be omitted. In another embodiment, referring to FIGS. 4c, 4d, 4e and 4f, the protective medium 130 is a sealant layer; and a space 131 is formed between the protective medium 130 and the bendable carrier 110 to accommodate the bendable light emitting diode stripe 120, wherein the protective medium is utilized for covering a portion of the bendable carrier 110 (FIG. 4c and FIG. 4e) or for covering the whole bendable carrier 110 (FIG. 4d and FIG. 4f). In both cases, the bendable light emitting diode stripe 120 can be easily pulled out from tube shape of the protective medium 130 to renew or rework.

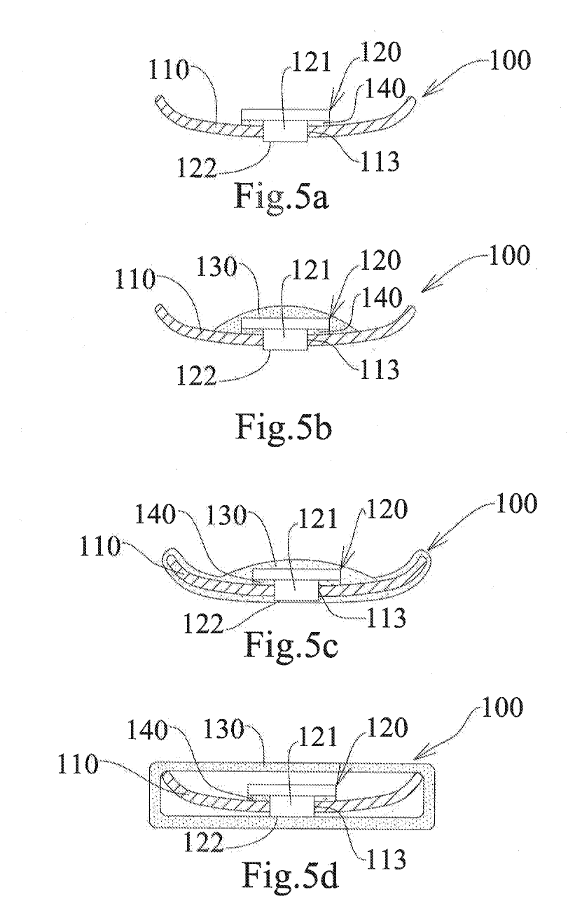

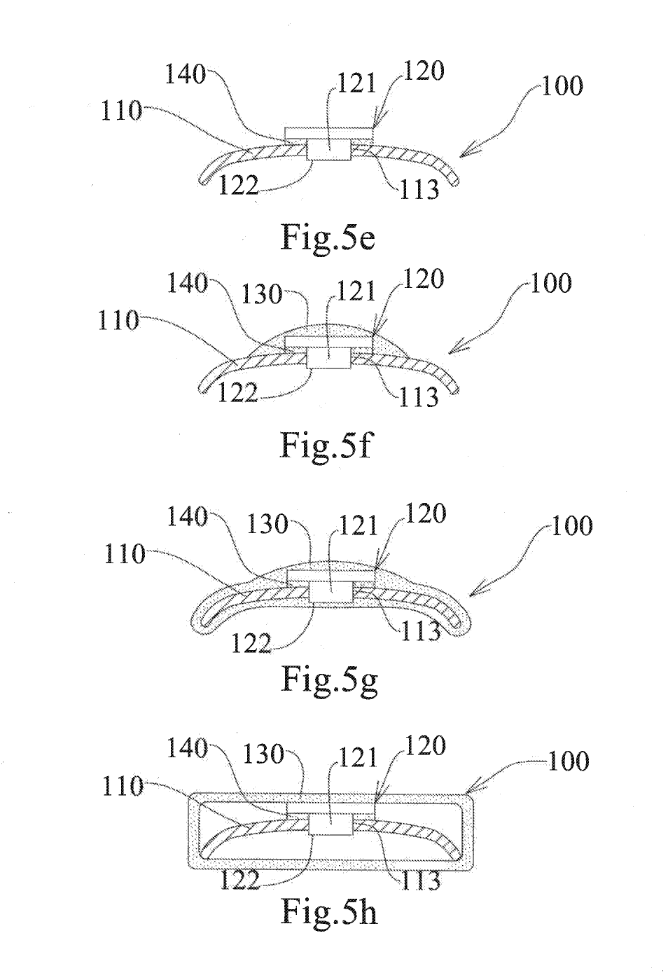

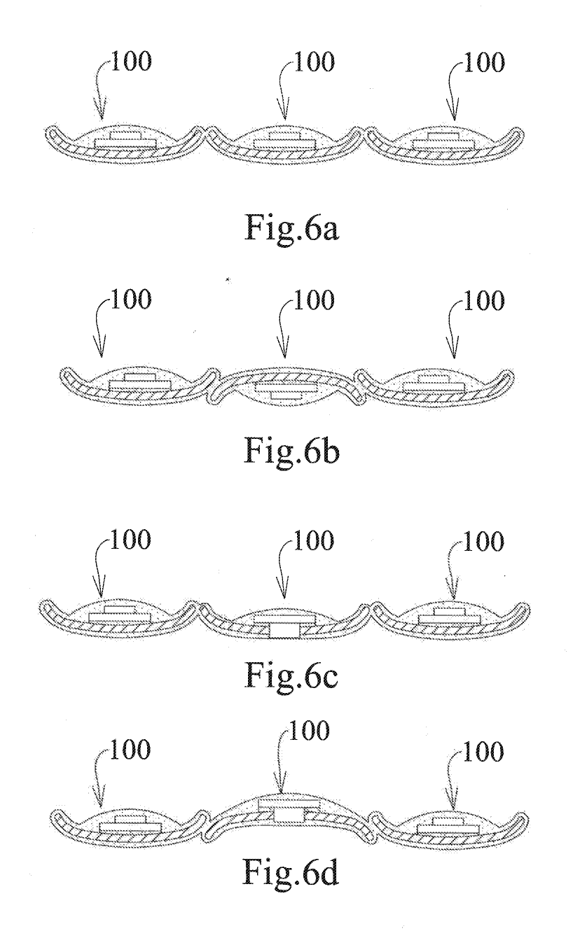

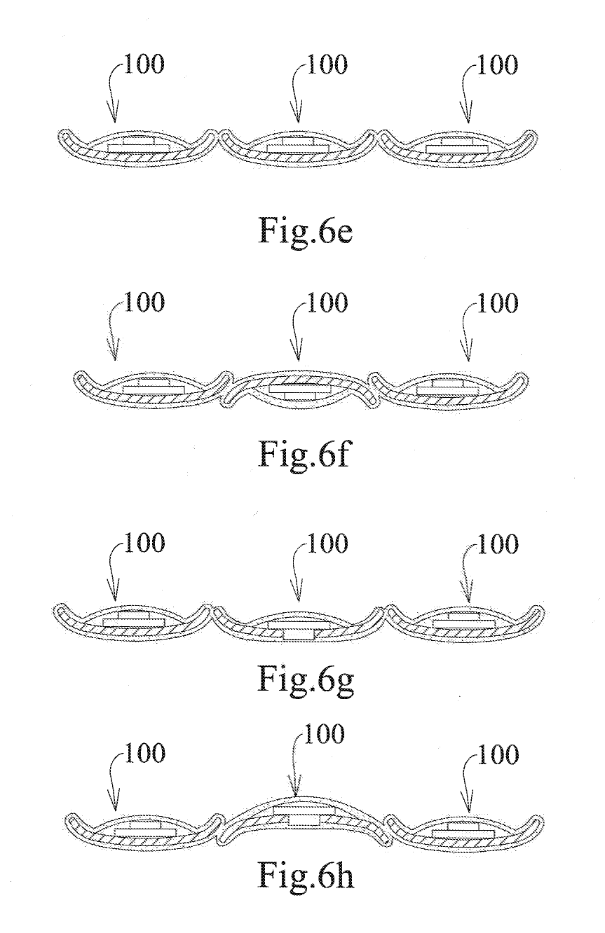

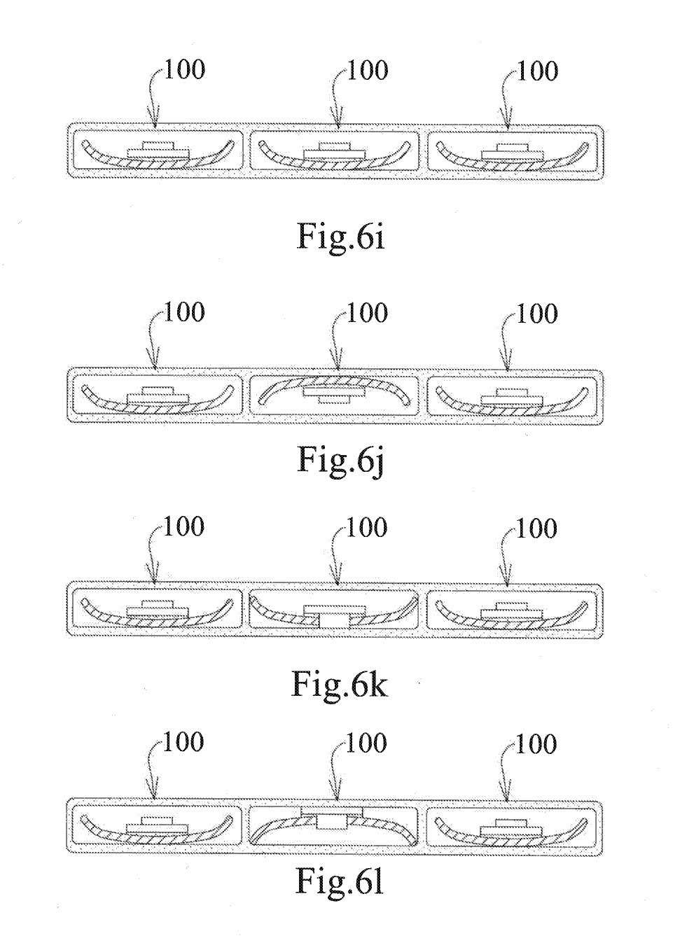

In another embodiment, referring to FIGS. 5a, 5b, 5c, 5d, 5e, 5f, 5g and 5h, the bendable carrier 110 further comprises multiple openings 113 allowing multiple emitting parts 122 of the light emitting diode chips 121 to pass through. Besides, in different design, referring to FIGS. 6a, 6b, 6c 6d, 6e, 6f, 6g, 6h, 6i, 6j, 6k and 6l, a plurality of illuminating devices 100, not limited to equal illuminating device 100, can be parallel arranged in a series connection, a parallel connection or the combination thereof to form a surface illuminating device.

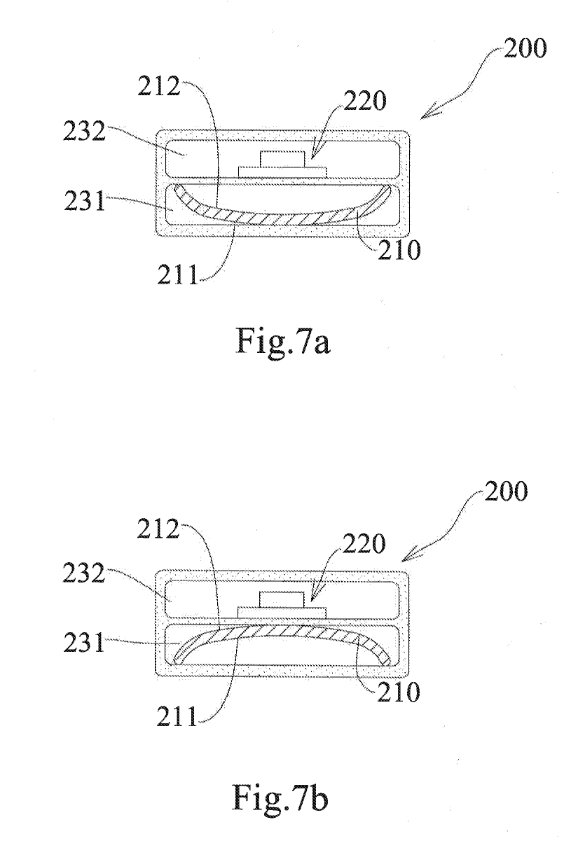

Referring to FIGS. 7a and 7b, a still another embodiment of the present invention, the difference between this embodiment and the above mentioned embodiment is the bendable light emitting diode stripe dese not set on the bendable carrier directly. As shown in these figures, the illuminating device 200 comprises a bendable supporting element 210, at least a bendable light emitting diode stripe 220, and a flexible tube 230. The bendable supporting element 210 has a belt structure with an arcuate cross-section, and including a convex surface 211 and a concave surface 212, to firmly maintain the bendable supporting element 210 in an elongated state when the bendable supporting element 210 is not bent; also enables the bendable supporting element 210 to recover to the elongated state from a bent state. Different arrangement of the bendable supporting element 210 has been illustrated in FIGS. 7a and 7b. The bendable supporting element 210 and the bendable light emitting diode stripe 220 have been described in detail above, hence unnecessary details are no longer given herein. Besides, the interior space of the flexible tube 230 is parallel separated to a first through hole 231 and the second through hole 232, wherein the bendable supporting element 210 is arranged in the first through hole 231 and the bendable light emitting diode stripe 220 is arranged in the second through hole 232; and the flexible tube 230 is composed of transparent or translucent materials.

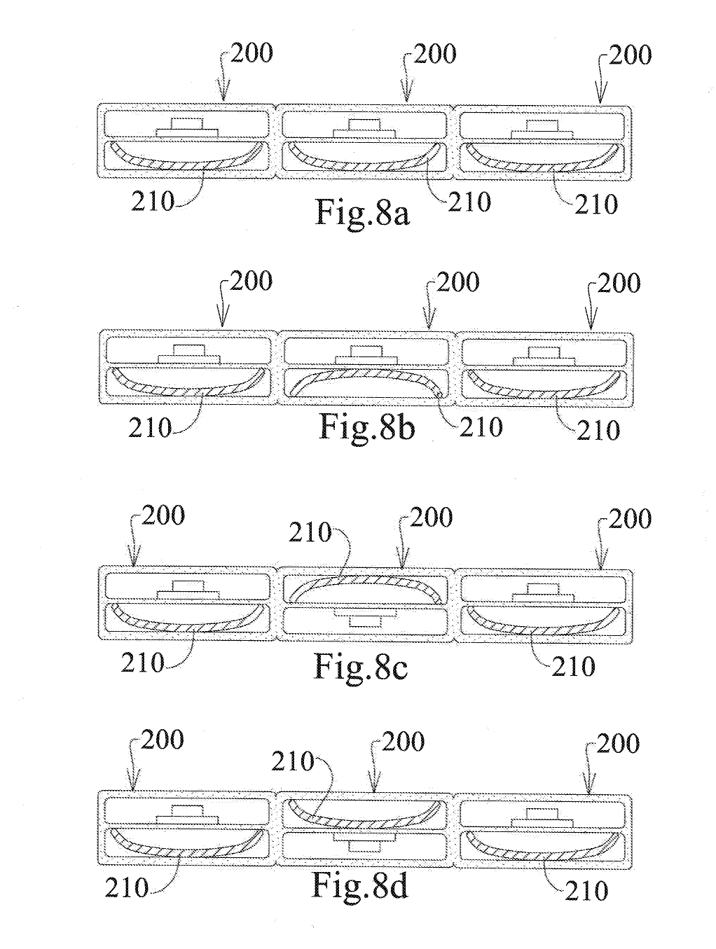

In yet another embodiment, as shown in FIGS. 8a, 8b, 8c and 8d, more than two of the illuminating devices 200 may be parallel arranged in a series connection, a parallel connection or the combination thereof to form a surface illuminating device, wherein each bendable supporting element 210 can be bent to wanted shapes to improve the viewing angle.

In still another embodiment, the bendable carrier can be shaped as a disc-like structure or an elliptic disc-like structure for different design.

In conclusion, the present invention is directed to an illuminating device. By using a belt structure such like tape measure, different shapes of the illuminating device can be feasibly adjusted. As a result, it solves the problem of limited viewing angle and provides better illumination. Moreover, variety of lighting effects can be realized; the illuminating device of the present invention renders LED an ideal element for indoor lighting, outdoor lighting and interior design.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An illuminating device comprising:
a bendable carrier, wherein the bendable carrier has a belt structure with an arcuate cross-section, and including a convex surface and a concave surface, to firmly maintain the bendable carrier in an elongated state when the bendable carrier is not bent; also enables the bendable carrier to recover to the elongated state from a bent state; and
at least a bendable light emitting diode stripe comprising multiple light emitting diode chips, wherein the bendable light emitting diode stripe is arranged at least on one of the convex surface and the concave surface.

2. The illuminating device according to claim 1, wherein when the bendable carrier is in the elongated state, the belt structure has a smaller anti-bending force at a first direction and has a larger anti-bending force at a second direction, wherein the first direction is orthogonal to an elongated axis of the elongated state of the belt structure and extends along the plane of a cross-section of the belt structure; the second direction is opposite to the first direction.

3. The illuminating device according to claim 1, wherein the bendable carrier is shaped as a disc-like structure or an elliptic disc-like structure.

4. The illuminating device according to claim 1, wherein the bendable light emitting diode stripe is fastened on at least one of the convex surface and the concave surface by an adhesive layer.

5. The illuminating device according to claim 1 further comprising a protective medium covering the bendable light emitting diode stripe.

6. The illuminating device according to claim 5, wherein the bendable light emitting diode stripe is fastened on the concave surface of the bendable carrier and the protective medium is a sealant layer for closely covering the bendable light emitting diode stripe or closely covering the bendable light emitting diode stripe and the bendable carrier simultaneously.

7. The illuminating device according to claim 6, wherein the sealant layer is composed of transparent or translucent adhesive sealants.

8. The illuminating device according to claim 5, wherein the bendable light emitting diode stripe is fastened on the convex surface of the bendable carrier and the protective medium is a sealant layer for closely covering the bendable light emitting diode stripe or closely covering bendable light emitting diode stripe and the bendable carrier simultaneously.

9. The illuminating device according to claim 8, wherein the sealant layer is composed of transparent or translucent adhesive sealants.

10. The illuminating device according to claim 5, wherein the protective medium is a flexible tube covering the bendable light emitting diode stripe and the bendable carrier; and the flexible tube is composed of transparent or translucent materials.

11. The illuminating device according to claim 5, wherein the protective medium is a sealant layer; and a space is formed between the protective medium and the bendable carrier to accommodate the bendable light emitting diode stripe.

12. The illuminating device according to claim 11, wherein more than two of the illuminating devices parallel arranged in a series connection, a parallel connection or the combination thereof to form a surface illuminating device.

13. The illuminating device according to claim 1, wherein the bendable carrier further comprises multiple openings allowing multiple emitting parts of the light emitting diode chips to pass through.

14. The illuminating device according to claim 1, wherein ore than two of the illuminating devices are parallel arranged in a series connection, a parallel connection or the combination thereof to form a surface illuminating device.

15. The illuminating device according to claim 1, wherein the bendable carrier is a stainless steel tapeline or a manganese steel tapeline.

16. An illuminating device comprising:
a bendable supporting element, wherein the bendable supporting element has a belt structure with an arcuate cross-section, and including a convex surface and a concave surface, to firmly maintain the bendable carrier in an elongated state when the bendable carrier is not bent; also enables the bendable carrier to recover to the elongated state from a bent state;
at least a bendable light emitting diode stripe comprising multiple light emitting diode chips; and
a flexible tube, wherein interior space of the flexible tube is parallel separated to a first through hole and the second through hole, wherein the bendable supporting element is arranged in the first through hole and the bendable light emitting diode stripe is arranged in the second through hole; the flexible tube is composed of transparent or translucent materials.

17. The illuminating device according to claim 16, wherein when the bendable supporting element is in the elongated state, the belt structure has a smaller anti-bending force at a first direction and has a larger anti-bending force at a second direction, wherein the first direction is orthogonal to an elongated axis of the elongated state of the belt structure and extends along the plane of a cross-section of the belt structure; the second direction is opposite to the first direction.

18. The illuminating device according to claim 16, wherein the bendable carrier is shaped as a disc-like structure or an elliptic disc-like structure.

19. The illuminating device according to claim 16, wherein more than two of the illuminating devices are parallel arranged in a series connection, a parallel connection or the combination thereof to form a surface illuminating device.

20. The illuminating device according to claim 16, wherein the bendable carrier is a stainless steel tapeline or a manganese steel tapeline.
